(19) United States
(12) Patent Application Publication
(10) Pub. No.: US 2009/0290628 A1
(43) Pub. Date: Nov. 26, 2009

(54) WIRELESS COMMUNICATION DEVICE AND METHOD OF DISPLAYING WIRELESS COMMUNICATION STATE

(75) Inventor: Naohiro MATSUMOTO, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kawasaki (JP)

(21) Appl. No.: 12/436,555

(22) Filed: May 6, 2009

(30) Foreign Application Priority Data
May 23, 2008 (JP) 2008-135024

(51) Int. Cl. H04B 17/00

(52) U.S. Cl. 375/225

(57) ABSTRACT

Provided is a wireless communication device that receives at least one communication packet containing data rate information, including: a storage unit that receives the at least one communication packet and stores, in a memory unit, the data rate information contained in the at least one communication packet; a display data generation unit that generates display data rate information to be used for display, based on the data rate information stored in the memory unit; and a display unit that displays the display data rate information generated by the display data generation unit.

### BACKGROUND

1. Field of the Invention

The present invention relates to a wireless communication device and a method of displaying a wireless communication state. In particular, the present invention relates to a wireless communication device such as a portable electronic device having a wireless communication function to receive a communication packet containing data rate information, and to a method of displaying a wireless communication state.

2. Description of Related Art

In recent years, many portable electronic devices, such as a portable audio player and a digital camera, have a wired universal serial bus (USB) interface for data communication with a host device such as a personal computer. In this regard, however, every time such a portable electronic device is carried by a user, the portable electronic device has to be connected to or removed from the host device through a USB cable. Additionally, it is necessary to manage the USB cable. Therefore, much attention has been recently paid to certified wireless USB (hereinafter, referred to as “WUSB”) which is a standard for short-distance wireless communication.

A WUSB protocol is a standard that supports multiple data rates. For example, a WUSB 1.0 standard defines eight kinds of data rates, i.e., 53.3 Mbit/s (Mbit/s is hereinafter abbreviated as “Mbps”), 80 Mbps, 106.7 Mbps, 160 Mbps, 200 Mbps, 320 Mbps, 400 Mbps, and 480 Mbps. Further, the WUSB protocol is defined such that data rate information indicating a data rate is contained in a communication packet to be transmitted from the host device. A device unit is configured to transmit subsequent communication packets based on the data rate information contained in the received communication packet.

Examples of technologies related to a wireless communication device are described below.

Japanese Unexamined Patent Application Publication No. 2006-238146 discloses a technology related to a device unit capable of wireless USB communication. The device unit transmits test data in response to a communication request from a host device capable of wireless USB communication, and receives return data from the host device to detect and display a state of communication with the host device based on the test data and the return data. According to the technology described in Japanese Unexamined Patent Application Publication No. 2006-238146, the test data is transmitted a predetermined number of times, and the state of communication with the host device can be detected based on multiple received return data items.

Further, Japanese Unexamined Patent Application Publication No. 2007-13330 discloses a technology related to a wireless communication device for performing packet data communication with a wireless base station in personal handyphone system (PHS) communication. The wireless communication device monitors a flow rate of data during communication, and increases or decreases a bandwidth by switching the number of slots according to the data flow rate, to thereby display the bandwidth used in the communication at a certain point.

Furthermore, Japanese Unexamined Patent Application Publication No. 2007-288708 discloses a technology related to a communication device that changes a transmission system depending on a communication state in wireless communication, and secures the maximum data transmission rate, thereby improving throughput. The communication device performs data rate control on the host device side in the wireless USB communication.

### SUMMARY

In the technologies disclosed in Japanese Unexamined Patent Application Publication Nos. 2006-238146, 2007-13330, and 2007-288708, however, it is impossible to display a state of data communication with a host device in real time in a device unit for performing wireless communication using data rate information contained in a communication packet as in the WUSB communication. This causes a problem in that it is difficult for a user to search for an installation location of the device unit at which higher throughput can be obtained.

Though the communication device disclosed in Japanese Unexamined Patent Application Publication No. 2007-288708 is capable of performing data rate control on the host device side, consideration is not given to the display of the communication state on the device unit side. A data transmission rate between the device unit and the host device depends also on the installation location of the device unit. Accordingly, the data transmission rate can be adjusted also by changing the installation location of the device unit with respect to the host device. When a portable electronic device or the like is used as the device unit, however, it is difficult to solve the above-mentioned problem in that the optimal installation location of the device unit with respect to the host device cannot be recognized on the device unit side based on the communication state.

Further, Japanese Unexamined Patent Application Publication No. 2006-238146 discloses the technology of displaying the state of communication with the host device by transmitting/receiving the test data prior to the execution of data communication. Accordingly, when the installation location of the device unit is moved after the communication state is displayed, the test data needs to be transmitted/received again, which makes it impossible to display the communication state itself in real time in the actual data communication.

Furthermore, Japanese Unexamined Patent Application Publication No. 2007-13330 discloses the technology related to PHS communication in which the number of slots through which data can be transmitted and received is set on the wireless communication device side based on the communication state. In the PHS communication, a communication speed can be determined using a pair of slots for transmission and reception. In the wireless communication such as WUSB communication, however, data transmission/reception speeds are not always the same. Therefore, the communication speed cannot be determined in the same manner as the PHS communication, that is, in the technology described in Japanese Unexamined Patent Application Publication No. 2007-13330.

A first exemplary aspect of an embodiment of the present invention is a wireless communication device that receives at least one communication packet containing data rate information. The wireless communication device includes a storage unit that receives the at least one communication packet and stores, in a memory unit, the data rate information contained in the at least one communication packet; a display data generation unit that generates display data rate information to be used for display, based on the data rate information stored in the memory unit; and a display unit that displays the display data rate information generated by the display data generation unit.

A second exemplary aspect of an embodiment of the present invention is a method of displaying a wireless communication state of a wireless communication device that receives at least one communication packet containing data rate information. The method includes receiving the at least one communication packet; storing, in a memory unit, the data rate information contained in the at least one communication packet; generating display data rate information to be used for display, based on the data rate information stored in the memory unit; and displaying the display data rate information generated in the generating.

FIG. 1 shows an example of the operation and effect of a wireless communication device and a method of displaying a wireless communication state according to an exemplary embodiment of the present invention. FIG. 1 shows a case where a data transfer 31 is performed between a wireless communication device unit 1a and a wireless communication host device 2. First, the wireless communication device unit la displays contents as shown in a light emitting diode (LED) image 19a, for example, based on data rate information contained in a communication packet obtained by the data transfer 31. In this case, the LED image 19a indicates that the data transmission rate for the data transfer 31 is low. Accordingly, a user of the wireless communication device unit la carries out a movement 32 of the position of the wireless communication device unit, thereby moving the wireless communication device unit 1a to an installation location of a wireless communication device unit 1b. After that, a data transfer 33 is performed between the wireless communication device unit 1b and the wireless communication host device 2. Then, the wireless communication device unit 1b displays contents as shown in an LED image 19b based on data rate information contained in a communication packet obtained by the data transfer 33. In this case, the LED image 19b indicates that the data transmission rate of the data transfer 33 is high. In this manner, the wireless communication device unit displays the data rate information contained in the communication packet in the data communication performed at the installation location. Thus, the user of the wireless communication device can recognize the communication state at the installation location. Further, the movement of the wireless communication device unit to an installation location at which the data rate information indicates a higher data rate can be assisted, if necessary.

According to an exemplary embodiment of the present invention, it is possible to provide a wireless communication device and a method of displaying a wireless communication state, in which a wireless communication device unit visualizes data rate information contained in a communication packet, thereby enabling a user of the wireless communication device unit to search for an optimal location for data communication, and enabling maximization of the effective transfer throughput.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing an example of the operation and effect of a wireless communication device and a method of displaying a wireless communication state according to an exemplary embodiment of the present invention;

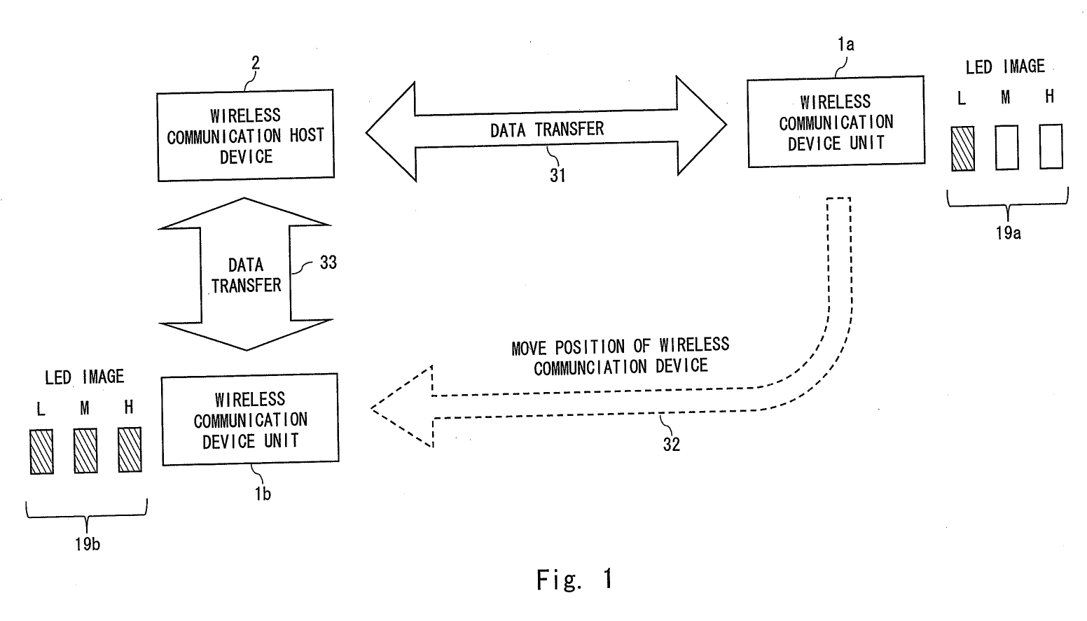

FIG. 2 is a block diagram showing a configuration of a wireless communication device according to a first exemplary embodiment of the present invention;

FIG. 3 is a diagram showing an example of communication packets to be transmitted and received according to an exemplary embodiment of the present invention;

FIG. 4 is a diagram showing an example of communication packets to be transmitted and received according to an exemplary embodiment of the present invention;

FIG. 5 is a flowchart showing processing for storing data rate information according to the first exemplary embodiment of the present invention;

FIG. 6 is a flowchart showing processing for updating data buffers when the wireless communication device according to the first exemplary embodiment of the present invention receives data;

FIG. 7 is a flowchart showing processing for updating the data buffers when the wireless communication device according to the first exemplary embodiment of the present invention receives data;

FIG. 8 is a flowchart showing processing for generating and displaying display data rate information according to the first exemplary embodiment of the present invention; and

FIG. 9 is a table showing an example of the number of successful communications of the data rate information according to the first exemplary embodiment of the present invention.

### DETAILED DESCRIPTION OF THE EXEMPLARY EMBODIMENTS

Hereinafter, specific embodiments to which the present invention is applied will be described in detail with reference to the accompanying drawings. In the drawings, the same components are denoted by the same reference symbols, and a redundant explanation thereof is omitted as appropriate to clarify the explanation.

### First Exemplary Embodiment

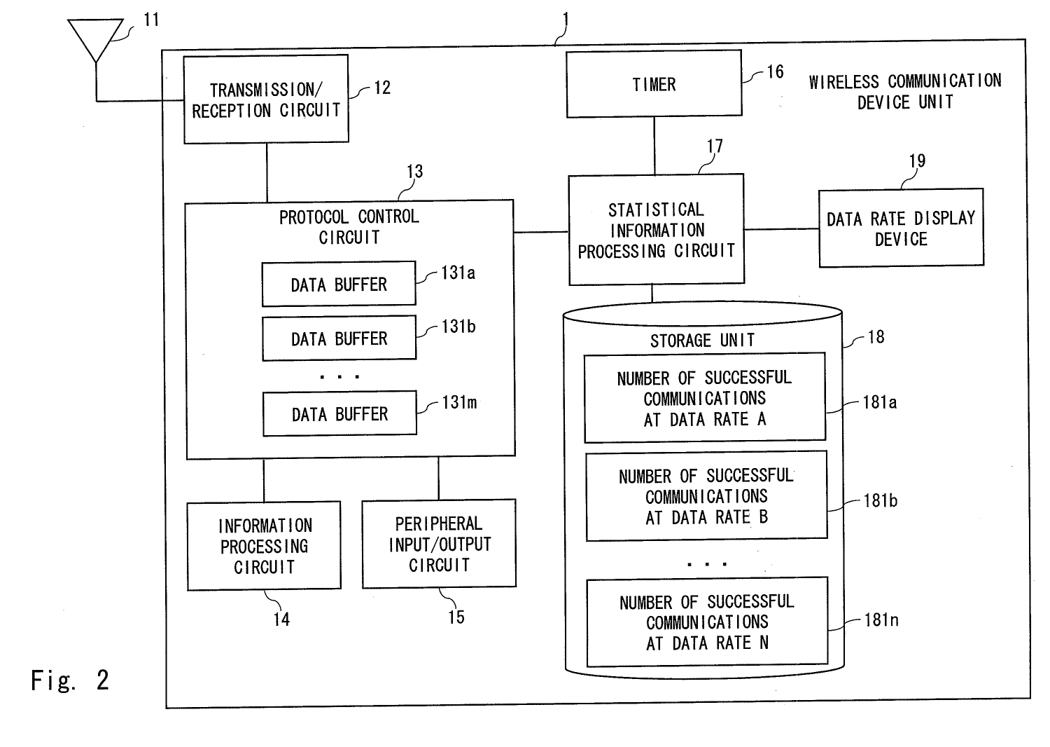

FIG. 2 is a block diagram showing a configuration of a wireless communication device unit 1 according to a first exemplary embodiment of the present invention. The wireless communication device unit 1 is a portable electronic device such as a portable audio player or a digital camera capable of WUSB communication. Further, the wireless communication device unit 1 performs data communication with a host device (for example, the wireless communication host device 2 of FIG. 2) such as a personal computer capable of WUSB communication. Furthermore, the wireless communication device unit 1 displays information related to a data transmission rate in the data communication (hereinafter, referred to as “data rate information”). The term “data rate information” refers to, for example, information indicating eight kinds of data rates defined in the WUSB standard.

It is assumed that the wireless communication host device 2 that performs data communication with the wireless communication device is a device capable of adjusting subsequent data rate information based on a result of the data communication. For example, the wireless communication host device is preferably a device that controls the data rate as described in the Japanese Unexamined Patent Application Publication No. 2007-288708, but is not limited thereto.

The wireless communication device unit 1 includes an antenna 11, a transmission/reception circuit 12, a protocol control circuit 13, an information processing circuit 14, a peripheral input/output circuit 15, a timer 16, a statistical information processing circuit 17, a storage unit 18, and a data rate display device 19.

The antenna 11 is used to transmit/receive radio waves for data communication to/from a given host device capable of WUSB communication. The transmission/reception circuit 12 converts an analog signal received as radio waves from the antenna 11 into a digital signal, and sends the digital signal to the protocol control circuit 13. Further, the transmission/reception circuit 12 converts the digital signal received from the protocol control circuit 13 into an analog signal, and sends the analog signal as radio waves to the antenna 11.

The protocol control circuit 13 analyzes or generates a communication packet contained in the digital signal transmitted/received to/from the transmission/reception circuit 12 according to the WUSB protocol. Further, the protocol control circuit 13 performs various processings in the wireless communication device unit 1 through the communication with the information processing circuit 14 and the peripheral input/output circuit 15. Then, the protocol control circuit 13 notifies the statistical information processing circuit 17 after the transmission/reception of data is completed. Note that examples of the various processings performed in the wireless communication device unit 1 through the communication with the information processing circuit 14 and the peripheral input/output circuit 15 include transmission of music data using a portable audio player, and transmission of shot data using a digital camera.

Further, the protocol control circuit 13 includes data buffers 131a, 131b, . . . , and 131m, each of which serves as a temporary storage area for the transmitted/received data. The protocol control circuit 13 stores the data contained in the communication packets that have been successfully received, in any of the data buffers 131a to 131m. Further, the protocol control circuit 13 stores the data to be transmitted in any of the data buffers 131a to 131m prior to transmission of the data. Then, when the data transmission is successful, the protocol control circuit 13 clears the data buffer storing the data contained in the communication packet that has been successfully transmitted, or stores the data to be subsequently transmitted. Note that the number of data buffers may be at least one.

The protocol control circuit 13 further includes a plurality of memories (not shown) for temporarily storing the data rate information. The protocol control circuit 13 stores the data rate information contained in communication packets that have been successfully received, in the memories. Further, upon receiving a data transmission request, the protocol control circuit 13 stores the data rate information, which is contained in the data transmission request and is to be assigned at the time of data transmission, in the memories.

Furthermore, with updating of the data buffers 131a to 131m as a trigger, the protocol control circuit 13 notifies the statistical information processing circuit 17 of the number of updated data buffers and the data rate information stored in the memories.

The timer 16 notifies the statistical information processing circuit 17 at every predetermined cycle. The predetermined cycle is, for example, one second.

The storage unit 18 is a storage unit having areas for storing the number of successful communications for each data rate information. The term “number of successful communications” refers to the number of communication packets that have been successfully transmitted or received, among the communication packets containing data in the data communication between the wireless communication device unit 1 and the wireless communication host device 2. As shown in FIG. 2, the storage unit 18 stores the number of successful communications 181a at a data rate A, the number of successful communications 181b at a data rate B, . . . , and the number of successful communications 181n at a data rate N. In this case, the data rate A, the data rate B, . . . , and the data rate N are desirably selected from the eight kinds of data rates defined in the WUSB standard. More specifically, for example, the number of successful communications 181a represents the number of communication packets that have been successfully transmitted and received at a data rate of 53.5 Mbps. Likewise, the number of successful communications 181b at the data rate B represents the number communication packets that have been successfully transmitted and received at a data rate of 80 Mbps, . . . , and the number of successful communications 181n at the data rate N represents the number of communication packets that have been successfully transmitted and received at a data rate of 480 Mbps. Note that the number of kinds of data rate information may be at least one, and a plurality of data rates may be contained in a single data rate information item.

Note that the storage unit 18 may be a non-volatile memory such as a hard disk drive, a magneto optical disk drive, or a flash memory, or may be a volatile memory such as a dynamic random access memory (DRAM) or a register.

The statistical information processing circuit 17 receives a notification indicating the updating of the data buffers, the number of updated data buffers, and the data rate information, from the protocol control circuit 13. In this case, the statistical information processing circuit 17 adds the value of the number of updated data buffers to any one of the numbers of successful communications 181a, 181b, . . . , and 181n corresponding to the data rate information, and stores the result in the storage unit 18. Further, upon notification from the timer 16, the statistical information processing circuit 17 refers to the storage unit 18 and generates display data rate information based on the data rate information indicating the largest number of successful communications. Then, the statistical information processing circuit 17 notifies the data rate display device 19 of the generated display data rate information. The term “display data rate information” refers to information to be displayed on the data rate display device 19.

The data rate display device 19 receives the display data rate information from the statistical information processing circuit 17, and performs display based on the display data rate information. For example, the data rate display device 19 may include LEDs corresponding to the data rate information, and may light the corresponding LEDs. Alternatively, the data rate display device 19 may classify multiple data rate information items into low-speed, medium-speed, and high-speed, and may include LEDs corresponding to the speeds. In these cases, the display data rate information may be a signal for lighting the LEDs corresponding to the data rate information selected by the statistical information processing circuit 17. Alternatively, the data rate display device 19 may include a liquid crystal display device to display numerical values, characters, and the like of the data rate information. In this case, the display data rate information may be information such as numerical values or characters to be displayed on the liquid crystal display.

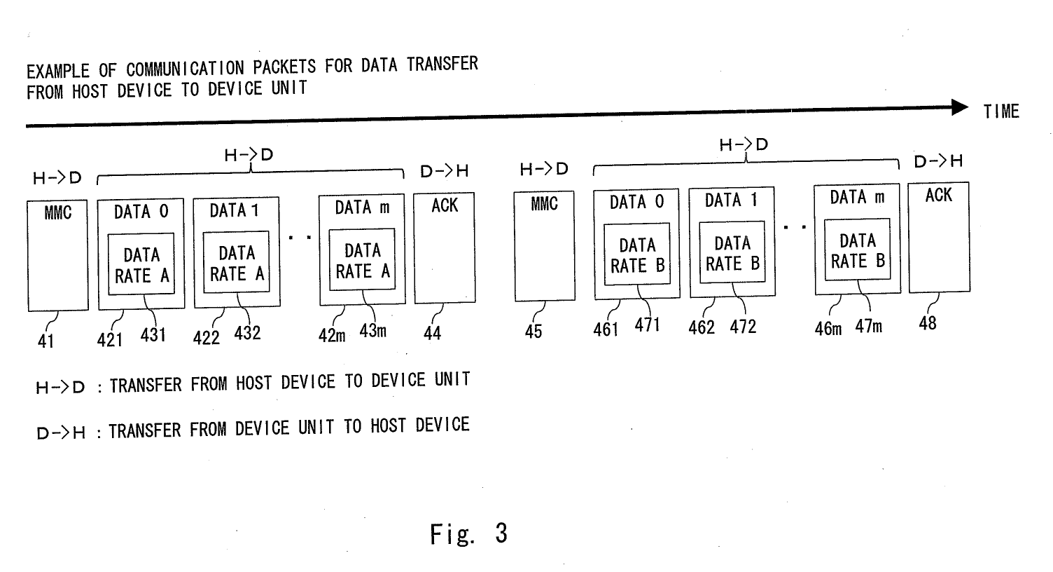

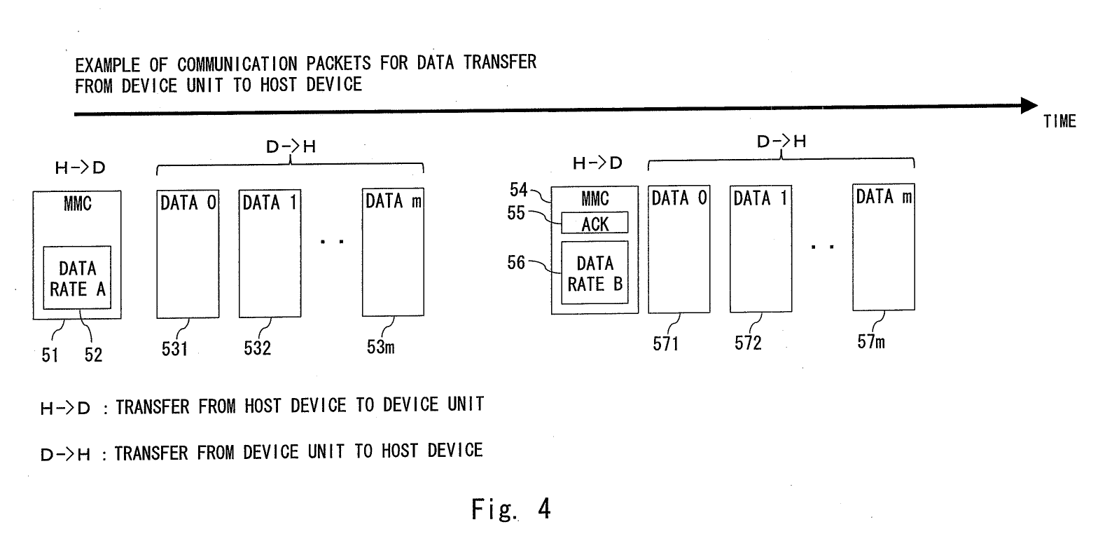

FIGS. 3 and 4 show examples of communication packets to be transferred according to an exemplary embodiment of the present invention. FIG. 3 shows data transfer from the wireless communication host device 2 to the wireless communication device unit 1. As described above, according to the WUSB protocol standard, the data rate information can be assigned to the communication packets transmitted from a given host device. Specifically, FIG. 3 shows an example in which the wireless host device 2 changes the data rate from the data rate A to the data rate B in the data transfer to the communication device 1. Referring to FIG. 3, communication packets 41, 42-1 to 42-m, and 44 each show a case where data is transmitted at the data rate A. Further, referring to FIG. 3, communication packets 45, 46-1 to 46-m, and 48 each show a case where data is transmitted at the data rate B which is different from the data rate A. Furthermore, referring to FIG. 3, in the data transfer from the wireless communication host device 2 to the wireless communication device unit 1, the communication packet 41 and the communication packets 42-1 to 42-m are transmitted from the wireless communication host device 2 to the wireless communication device unit 1. Then, referring to FIG. 3, only the communication packet 44 containing acknowledgement (ACK) information described later is transmitted from the wireless communication device unit 1 to the wireless communication host device 2. Here, the communication packet 41 contains micro-scheduled management commands (MMC) which are control packets defined in the WUSB standard. Further, the communication packet 41 thereafter serves as data transmission start notification for notifying the wireless communication device unit 1 of start of the data transmission from the wireless communication host device 2. Note that the MMC contains, for example, host identification information, device control information, and a specified time for transmitting the subsequent MMC.

Regarding the communication packets 42-1 to 42-m, data to be transferred in the data communication corresponding to the communication packet 41 serving as the data transmission start notification is divided into the communication packets to be stored. Further, the communication packets 42-1 to 42-m contain data rate information items 43-1 to 43-m each indicating a data rate used when the wireless communication host device 2 transmits the respective communication packets to a header area. The wireless communication device unit 1 extracts the data rate information items 43-1 to 43-m from the received communication packets 42-1 to 42-m, thereby obtaining data rate information at the time of data communication using the communication packets.

Further, the communication packet 44 contains the ACK information indicating a normal reception response to the wireless communication host device 2, in the case where the wireless communication device unit 1 has normally received the communication packet 41 and the communication packets 42-1 to 42-m.

Furthermore, the communication packet 45, the communication packets 46-1 to 46-m, and the communication packet 48 respectively correspond to the communication packet 41, the communication packets 42-1 to 42-m, and the communication packet 44, and have the same configuration as that described above, so the description thereof is omitted. Note that data rate information items 47-1 to 47-m respectively contained in the communication packets 46-1 to 46-m do not necessarily match the data rate information items 43-1 to 43-m, and may be different data rate information items.

FIG. 4 shows data transfer from the wireless communication device unit 1 to the wireless communication host device 2. Specifically, FIG. 4 shows an example in which the wireless host device 2 changes the data transmission rate for use in transferring data from the communication device 1 to the wireless host device 2, from the data rate A to the data rate B, based on the data rate information contained in the communication packets transmitted from the host device, in the same manner as in the data transfer from the wireless communication host device 2 to the wireless communication device unit 1 as shown in FIG. 3. Referring to FIG. 4, in the data transfer from the wireless communication device unit 1 to the wireless communication host device 2, a communication packet 51 is transmitted from the wireless communication host device 2 to the wireless communication device unit 1. Referring to FIG. 4, communication packets 53-1 to 53-m are transmitted from the wireless communication device unit 1 to the wireless communication host device 2. In this case, the communication packet 51 contains the MMC and serves as a data transmission instruction from the wireless communication host device 2, for instructing the data transmission from the wireless communication device unit 1 to the wireless communication host device 2. Further, the communication packet 51 contains data rate information 52 for specifying the data rate for use in the data transmission from the wireless communication device unit 1 in response to the data transmission request.

Regarding the communication packets 53-1 to 53-m, data to be transferred in the data communication corresponding to the communication packet 51 serving as the data transmission request is divided into the communication packets to be stored. In this case, the wireless communication device unit 1 transmits the communication packets 53-1 to 53-m based on the data rate information 52.

Further, like the communication packet 51, a communication packet 54 is transmitted from the wireless communication host device 2 to the wireless communication device unit 1, and contains the MMC and data rate information 56. The MMC contained in the communication packet 54 indicates a subsequent data transmission request. Furthermore, the communication packet 54 contains ACK information 55 indicating a normal reception response to the wireless communication device unit 1, in the case where the wireless communication host device 2 has normally received the communication packets 53-1 to 53-m. In other words, the ACK information 55 is a normal reception response from the wireless communication host device 2 to the wireless communication device unit 1 for the communication packets 53-1 to 53-m.

Regarding communication packets 57-1 to 57-m, data to be transferred in the data communication corresponding to the communication packet 54 serving as the data transmission request is divided into the communication packets to be stored. Further, the wireless communication device unit 1 transmits the communication packets 57-1 to 57-m based on the data rate information 56.

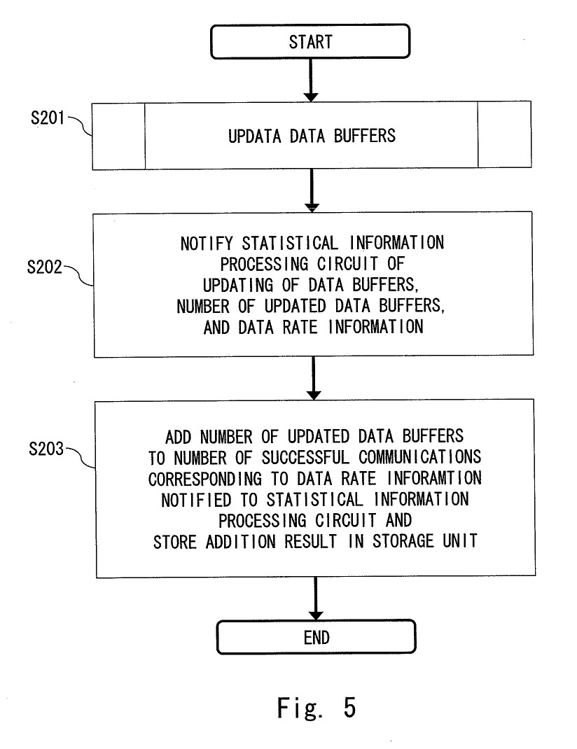

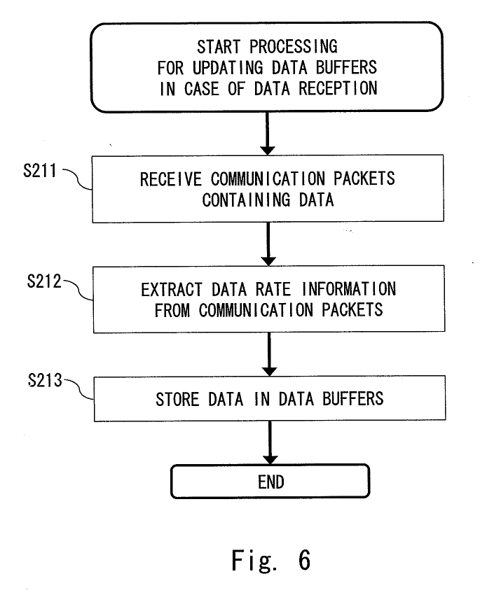

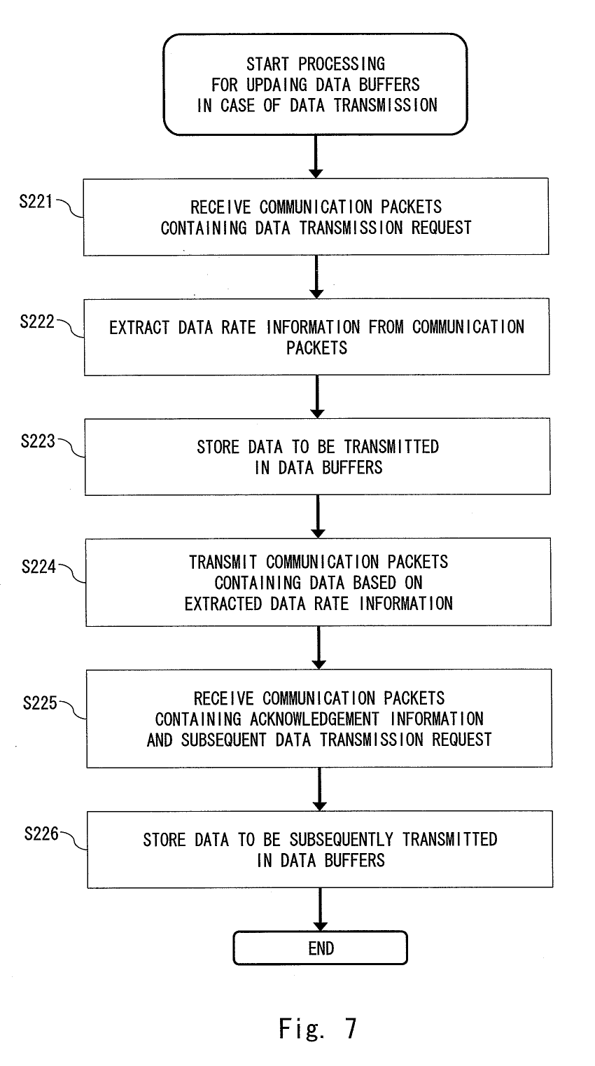

FIG. 5 is a flowchart showing processing for storing the data rate information according to the first exemplary embodiment of the present invention. A description is hereinafter given of a case where the wireless communication device unit 1 completes the data communication with the wireless communication host device 2, for example, a case where the wireless communication device unit 1 has successfully transmitted or received data. First, the wireless communication device unit 1 completes the data communication with the wireless communication host device 2, and updates the data buffers (S201). The processing performed in the case where the wireless communication device unit 1 has successfully received the data is illustrated in detail in FIG. 6. Further, the processing performed in the case where the wireless communication device unit 1 has successfully transmitted the data is illustrated in detail in FIG. 7. Note that the wireless communication device unit 1, which has failed to transmit or receive data, retransmits data or makes a retransmission request.

FIG. 6 is a flowchart showing processing for updating the data buffers when the wireless communication device unit 1 receives data. First, the wireless communication device unit 1 receives a communication packet containing the data (S211). For example, the wireless communication device unit 1 receives the communication packet 42-1 shown in FIG. 3.

Next, the wireless communication device unit 1 extracts the data rate information from the received communication packet (S212). For example, the protocol control circuit 13 of the wireless communication device unit 1 extracts the data rate information 43-1 from the communication packet 42-1, and stores the extracted information in the memories of the protocol control circuit 13.

Then, the wireless communication device unit 1 stores the data in the data buffers (S213). For example, the protocol control circuit 13 stores the data contained in the communication packet 42-1 in the data buffer 131a. In this manner, the data buffers are updated at the time of data reception.

Further, FIG. 7 is a flowchart showing processing for updating the data buffers when the wireless communication device unit 1 transmits data. First, the wireless communication device unit 1 receives a communication packet containing the data transmission request (S221). For example, the wireless communication device unit 1 receives the communication packet 51 shown in FIG. 4.

Next, the wireless communication device unit 1 extracts data rate information from the received communication packet (S222). For example, the protocol control circuit 13 of the wireless communication device unit 1 extracts the data rate information 52 from the communication packet 51, and stores the extracted information in the memories of the protocol control circuit 13. Then, the protocol control circuit 13 communicates with the information processing circuit 14 and the peripheral input/output circuit 15, if necessary, based on the communication packet 51, to thereby generate data to be transmitted to the wireless communication host device 2.

After that, the wireless communication device unit 1 stores the data to be transmitted in the data buffers (S223). For example, the protocol control circuit 13 stores the generated data to be transmitted in the data buffers 131a to 131m.

Then, the wireless communication device unit 1 transmits the communication packet containing the data to be transmitted, based on the extracted data rate information (S224). For example, the wireless communication device unit 1 generates the communication packets 53-1 to 53-m shown in FIG. 4 containing the data stored in the data buffer 131a to 131m. Then, the wireless communication device unit 1 transmits the generated communication packets 53-1 to 53-m to the communication host device 2 based on the data rate information 52 stored in the memories.

After that, the wireless communication device unit 1 receives a communication packet containing the ACK information (S225). For example, the wireless communication device unit 1 receives the communication packet 54 shown in FIG. 4. Then, the protocol control circuit 13 extracts the ACK information 55 from the communication packet 54, and confirms that the transmission processing of Step S224 has been successfully finished. Further, since the data rate information 56 contains the data transmission request, in the same manner as in Step S222, the protocol control circuit 13 extracts the data rate information 52 from the communication packet 54, and generates data to be subsequently transmitted in response to the data transmission request of the communication packet 54 to the wireless communication host device 2, for example.

Then, the wireless communication device unit 1 stores the generated data to be subsequently transmitted, in the data buffers (S226). For example, the protocol control circuit 13 stores the generated data to be subsequently transmitted, in the data buffers 131a to 131m. In this manner, the data buffers are updated at the time of data transmission.

Referring again to FIG. 5, additional description is provided. The protocol control circuit 13 of the wireless communication device unit 1 notifies the statistical information processing circuit 17 of information indicating that the data buffers are updated, the number of updated data buffers, and the data rate information, after updating the data buffers in Step S201 (S202). For example, in the case of data reception, since the data buffer 131a is updated, the protocol control circuit 13 sets the number of updated data buffers to “1”, acquires the data rate information 43-1 (for example, “200 Mbps”) stored in the memories of the protocol control circuit 13, and notifies the statistical information processing circuit 17 of the acquired data rate information.

Moreover, for example, in the case of data transmission, since the data buffers 131a to 131m are updated, the protocol control circuit 13 sets the number of updated data buffers to “m”, acquires the data rate information 52 stored in the memories of the protocol control circuit 13, and notifies the statistical information processing circuit 17 of the acquired data rate information.

After that, the statistical information processing circuit 17 of the wireless communication device unit 1 adds the number of updated data buffers to the number of successful communications corresponding to the notified data rate information, and stores the addition result in the storage unit 18 (S203). For example, the statistical information processing circuit 17 refers to the storage unit 18 from the data rate information “200 Mbps” notified from the protocol control circuit 13, and acquires the value (for example, “8”) of the number of successful communications stored in a storage area corresponding to “200 Mbps”. Then, the statistical information processing circuit 17 stores “9” obtained by adding the number of updated data buffers “1” to the number of successful communications “8”, in the storage area corresponding to the data rate information “200 Mbps” of the storage unit 18.

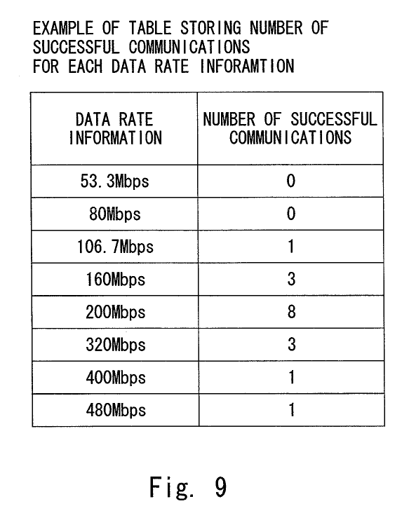

FIG. 9 shows an example of a table storing the number of successful communications for each data rate information according to the first exemplary embodiment of the present invention. Note that a distribution of the number of successful communications shown in FIG. 9 varies depending on a communication state between the wireless communication device unit 1 and the wireless communication host device 2, and an interval determined by the timer 16.

As described above, the processing for storing the data rate information according to the first exemplary embodiment of the present invention makes it possible to store the number of successful communications for each data rate information. In particular, when the multiple (e.g., “4”) data buffers are updated at the time of data transmission, for example, the statistical information processing circuit 17 stores “12”, which is obtained by adding the number of updated data buffers “4” to the number of successful communications “8”, in the storage area corresponding to the data rate information “200 Mbps” of the storage unit 18. Accordingly, when data is transmitted and received as multiple communication packets in burst transfer, for example, the numbers of successful communications can be updated collectively in response to a single notification from the protocol control circuit 13 to the statistical information processing circuit 17, thereby making it possible to improve the processing efficiency.

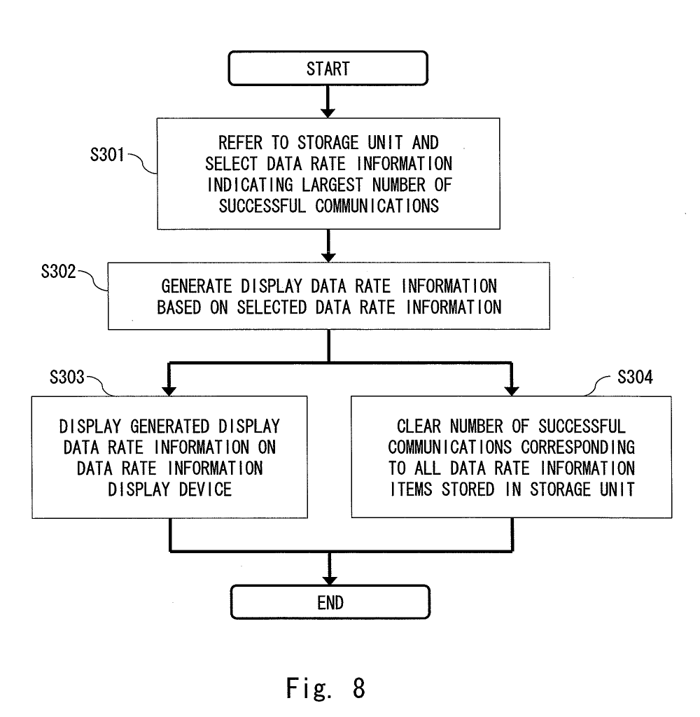

FIG. 8 is a flowchart showing processing for generating and displaying the display data rate information according to the first exemplary embodiment of the present invention. A description is hereinafter given of a case where the statistical information processing circuit 17 of the wireless communication device unit 1 operates in response to a notification from the timer 16. First, the statistical information processing circuit 17 of the wireless communication device unit 1 refers to the storage unit 18, and selects the data rate information indicating the largest number of successful communications (S301). In other words, the statistical information processing circuit 17 starts the processing for generating and displaying the display data rate information based on the notification from the timer 16. Then, the statistical information processing circuit 17 refers to the storage unit 18, and selects the data rate information “200 Mbps” indicating the number of successful communications “8” in the case shown in FIG. 9, for example.

Next, the statistical information processing circuit 17 generates the display data rate information based on the selected data rate information (S302). For example, the statistical information processing circuit 17 generates a signal indicative of the data rate information “200 Mbps” as the display data rate information.

After that, the statistical information processing circuit 17 displays the generated display data rate information on the data rate display device 19 (S303). Specifically, the statistical information processing circuit 17 notifies the data rate display device 19 of the display data rate information generated in Step S302. Then, the data rate display device 19 displays the data rate information based on the received display data rate information.

Further, after Step S302, the statistical information processing circuit 17 clears the numbers of successful communications corresponding to all the data rate information items stored in the storage unit 18 to “0” (S304). Thus, the numbers of successful data transmissions and receptions are added until a subsequent notification is received from the timer 16, thereby correctly displaying the data rate information for each predetermined interval. Note that Steps S304 and S303 are not necessarily executed in parallel.

As described above, according to the first exemplary embodiment of the present invention, the wireless communication device unit 1 is capable of visualizing the data rate information obtained when the number of successful data communications with the wireless communication host device 2 is largest. Accordingly, a user of the wireless communication device unit 1 can search for the optimal installation location of the wireless communication device unit 1 to perform data communication with the wireless communication host device 2. For example, it is possible to search for an installation location where the data rate information indicates 480 Mbps. As a result, the effective transfer throughput can be maximized.

In particular, according to an exemplary embodiment of the present invention, the data rate information contained in the communication packets for actual data transmission/reception is acquired, and the numbers of successful communications are added. Accordingly, even if the wireless communication device unit 1 is moved during the data communication, for example, the data rate information can be visualized in real time from the communication state obtained immediately after the movement.

### Other Exemplary Embodiments

Note that WUSB communication is a short-distance (mainly in a range of 1 m to 3 m) wireless communication technology, and thus a radio wave fluctuates due to the effects of the movement of people around, the other radio wave conditions, and the like. Accordingly, the communication state can be adjusted by changing the installation location of the wireless communication device unit.

Further, it is assumed that the wireless communication host device 2 according to an exemplary embodiment of the present invention is capable of selecting the data rate information for use in data communication based on the WUSB standard. In this case, the wireless communication host device 2 may arbitrarily select the optimal data rate based on information such as a packet error rate obtained as a result of data communication. Here, the packet error rate varies depending on a positional relationship between communication target devices or a positional relationship with a noise source. Thus, the effective throughput depends on the positioning of the wireless communication device unit 1. Therefore, the data rate information obtained during the data communication is visualized by the wireless communication device unit 1, thereby enabling the user of the wireless communication device unit 1 to search for the optimal position for data communication and to locate the wireless communication device unit 1 at the optimal position. As a result, the effective transfer throughput can be maximized.

Note that, in the wireless communication technology of the related art, it is possible that radio signals received from an antenna are processed using a transmission/reception circuit, and the strength of the radio wave is notified to a radio wave strength display device. In this regard, however, a reception strength of a WUSB device is not correlated with a transmission strength of a WUSB device, and thus, even if the radio wave strength can be utilized in searching for the optimal position at the time of data reception, the radio wave strength cannot be utilized in searching for the optimal position at the time of data transmission. Additionally, a WUSB host device and a WUSB device do not necessarily transmit radio signals for the WUSB standard with the same power. For this reason, it is difficult to determine the communication position for maximizing the throughput depending only on the reception strength.

Note that the above-mentioned storage unit 18 shown in FIG. 2 manages the numbers of successful communications for each data rate information, but the function of the storage unit 18 is not limited thereto. For example, the storage unit 18 may store the data rate information itself. In this case, in Step S301 of FIG. 8, the statistical information processing circuit 17 may add up the numbers of data rate information items themselves stored in the storage unit 18 for each data rate information.

Note that the data rate information displayed on the data rate display device 19 is not limited to the case where the communication has been successfully carried out. For example, even if the data communication fails, the protocol control circuit 13 may notify the statistical information processing circuit 17 of the number of packets that have been unsuccessfully transmitted and received, and the data rate information, and may store frequency information corresponding to the data rate information in the storage unit 18. In this case, the tendency toward success or failure of data communication can be analyzed, for example.

Moreover, according to an exemplary embodiment of the present invention, the timer 16 shown in FIG. 2 is not indispensable. In other words, every time receiving a data update notification from the protocol control circuit 13, the statistical information processing circuit 17 may generate the display data rate information from the data rate information indicating the largest number of successful communications at the time, and may display the display data rate information on the data rate display device 19.

Further, the display data rate information may be generated based on at least one-time transmission/reception of communication packets containing data.

Note that a given statistical processing may be performed on the information stored in the storage unit 18. For example, the statistical information processing circuit 17 may generate the display data rate information by calculating average data rate information based on a ratio of the number of successful communications to each data rate information.

While the above description has been made of an example in which the communication packets 42-1 to 42-m shown in FIG. 3 respectively contain the data rate information items 43-1 to 43-m, which indicate the same data rate information, the communication packets 42-1 to 42-m are not limited thereto. In other words, the data rate information items 43-1 to 43-m may indicate different data rate information. The same goes for the communication packets 46-1 to 46-m.

Further, the number of the communication packets 42-1 to 42-m and the number of the communication packets 46-1 to 46-m, as shown in FIG. 3, need not be the same, and the number of the communication packets 53-1 to 53-m and the number of the communication packets 57-1 to 57-m, as shown in FIG. 4, also need not be the same. The number of packets may be at least one.

Note that, in Step S212 of FIG. 6 and in Steps S222 and S225 of FIG. 7, the timing at which the data rate information is stored in the memories of the protocol control circuit 13 can be arbitrarily set. For example, even after data is stored in the data buffers, the data rate information may be notified from the protocol control circuit 13 to the statistical information processing circuit 17 at the time of Step S202 of FIG. 5. Thus, it does not matter whether the data rate information is stored in the memories of the protocol control circuit 13.

Further, the wireless communication device unit 1 according to the first exemplary embodiment of the present invention performs simple processing of the selection of the data rate information indicating the largest number of successful communications by the statistical information processing circuit 17, which contributes to power saving. In particular, the effect of saving power is exerted when a portable electronic device is used as the wireless communication device unit 1.

Furthermore, the present invention is not limited to the above exemplary embodiments, and various modifications can be made without departing from the gist of the present invention.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A wireless communication device that receives at least one communication packet containing data rate information, comprising:
storage unit that receives the at least one communication packet and stores, in a memory unit, the data rate information contained in the at least one communication packet;
display data generation unit that generates display data rate information to be used for display, based on the data rate information stored in the memory unit; and
display unit that displays the display data rate information generated by the display data generation unit.

2. The wireless communication device according to claim 1, wherein:
the at least one communication packet comprises a plurality of communication packets; and
the display data generation unit generates the display data rate information based on the data rate information regarding the plurality of communication packets stored in the memory unit.

3. The wireless communication device according to claim 2, wherein the display data generation unit generates the display data rate information by referring to the memory unit and selecting data rate information indicating the largest number of communications.

4. The wireless communication device according to claim 1, wherein the storage unit stores, in the memory unit, data rate information contained in at least one communication packet that has been successfully transmitted or received in a data communication.

5. The wireless communication device according to claim 4, wherein, in a case where a plurality of communication packets has been successfully transmitted or received in the data communication, the storage unit adds the number of the plurality of communication packets to the number of communications of the data rate information corresponding to the plurality of communication packets.

6. The wireless communication device according to claim 4, wherein the storage unit further stores, in the memory unit, data rate information contained in at least one communication packet that has been unsuccessfully transmitted or received in the data communication.

7. The wireless communication device according to claim 1, wherein the storage unit receives the at least one communication packet, and stores, in the memory unit, the data rate information contained in the at least one communication packet when a data buffer that temporarily stores data to be transferred is updated.

8. The wireless communication device according to claim 1, wherein, when the received communication packet contains data to be transferred, the storage unit stores, in the memory unit, the data rate information contained in the communication packet.

9. The wireless communication device according to claim 1, wherein, when the received communication packet includes a data transmission request, the storage unit transmits data in response to the data transmission request and then stores, in the memory unit, the data rate information contained in the communication packet.

10. The wireless communication device according to claim 1, wherein the data communication is performed based on certified wireless universal serial bus (USB).

11. A method of displaying a wireless communication state of a wireless communication device that receives at least one communication packet containing data rate information, the method comprising:
receiving the at least one communication packet;
storing, in a memory unit, the data rate information contained in the at least one communication packet;
generating display data rate information to be used for display, based on the data rate information stored in the memory unit; and
displaying the display data rate information generated in the generating.

12. The method of displaying a wireless communication state according to claim 11, wherein:
the at least one communication packet comprises a plurality of communication packets; and
generating the display data rate information based on the data rate information regarding the plurality of communication packets stored in the memory unit.

13. The method of displaying a wireless communication state according to claim 12, wherein generating the display data rate information by referring to the memory unit and selecting data rate information indicating the largest number of communications.

14. The method of displaying a wireless communication state according to claim 11, wherein storing, in the memory unit, data rate information contained in at least one communication packet that has been successfully transmitted or received in a data communication.

15. The method of displaying a wireless communication state according to claim 14, wherein, in a case where a plurality of communication packets has been successfully transmitted or received in the data communication, adding the number of the plurality of communication packets to the number of communications of the data rate information corresponding to the plurality of communication packets, and storing an addition result in the storage unit.

16. The method of displaying a wireless communication state according to claim 14, wherein further storing, in the memory unit, data rate information contained in at least one communication packet that has been unsuccessfully transmitted or received in the data communication.

17. The method of displaying a wireless communication state according to claim 11, wherein receiving the at least one communication packet and storing, in the memory unit, the data rate information contained in the at least one communication packet when a data buffer that temporarily stores data to be transferred is updated.

18. The method of displaying a wireless communication state according to claim 11, wherein, when the received communication packet contains data to be transferred, storing, in the memory unit, the data rate information contained in the communication packet.

19. The method of displaying a wireless communication state according to claim 11, wherein, when the received communication packet includes a data transmission request, transmitting data in response to the data transmission request before storing, in the memory unit, the data rate information contained in the communication packet.

20. The method of displaying a wireless communication state according to claim 11, wherein the data communication is performed based on certified wireless universal serial bus (USB).
